(19) United States
(12) Patent Application Publication
(10) Pub. No.: US 2018/0248600 A1
(43) Pub. Date: Aug. 30, 2018

(54) WIDEBAND SECTOR SWEEP USING WIDEBAND TRAINING (TRN) FIELD

(71) Applicant: QUALCOMM Incorporated, San Diego, CA (US)

(72) Inventors: Assaf Yaakov KASHER, Haifa (IL); Alecsander Petru EITAN, Haifa (IL); Amichai SANDEROVICH, Atlit (IL)

(21) Appl. No.: 15/444,492

(22) Filed: Feb. 28, 2017

(51) Int. Cl. H04B 7/0491; H04B 7/06

(52) U.S. Cl. CPC H04B 7/0491; H04B 7/0684

(57) ABSTRACT

Certain aspects of the present disclosure generally relate to beamforming training. For example, certain aspects of the present disclosure provide an apparatus for wireless communications. The apparatus generally includes a processing system configured to generate a plurality of transmit sector sweep frames for transmission on a set of channels. In certain aspects, each of the transmit sector sweep frames comprise a preamble portion to be output for transmission on the set of channels, and a wideband training field to be output for transmission on a bandwidth spanning the set of channels. In certain aspects, the apparatus also includes an interface configured to output the transmit sector sweep frames for transmission on the set of channels using different transmit beamforming sectors.

### BACKGROUND

### Field of the Disclosure

Certain aspects of the present disclosure generally relate to wireless communications and, more particularly, to beamforming training.

### Description of Related Art

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the issue of increasing bandwidth requirements that are demanded for wireless communications systems, different schemes are being developed to allow multiple STAs to communicate with a single access point by sharing the channel resources while achieving high data throughputs. Multiple Input Multiple Output (MIMO) technology represents one such approach that has emerged as a popular technique for communication systems. MIMO technology has been adopted in several wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (e.g., tens of meters to a few hundred meters).

The 60 GHz band is an unlicensed band which features a large amount of bandwidth and a large worldwide overlap. The large bandwidth means that a very high volume of information can be transmitted wirelessly. As a result, multiple applications, each requiring transmission of large amounts of data, can be developed to allow wireless communication around the 60 GHz band. Examples for such applications include, but are not limited to, game controllers, mobile interactive devices, wireless high definition TV (HDTV), wireless docking stations, wireless Gigabit Ethernet, and many others.

Operations in the 60 GHz band allow the use of smaller antennas as compared to lower frequencies. However, as compared to operating in lower frequencies, radio waves around the 60 GHz band have high atmospheric attenuation and are subject to higher levels of absorption by atmospheric gases, rain, objects, and the like, resulting in higher free space loss. The higher free space loss can be compensated for by using many small antennas, for example arranged in a phased array.

Multiple antennas may be coordinated to form a coherent beam traveling in a desired direction. An electrical field may be rotated to change this direction. The resulting transmission is polarized based on the electrical field. A receiver may also include antennas which can adapt to match or adapt to changing transmission polarity.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications in a wireless network.

Certain aspects of the present disclosure generally relate to beamforming training.

Certain aspects of the present disclosure provide an apparatus for wireless communications. The apparatus generally includes a processing system configured to generate a plurality of transmit sector sweep frames for transmission on a set of channels, each of the transmit sector sweep frames comprising a preamble portion to be output for transmission on the set of channels, and a wideband training field to be output for transmission on a bandwidth spanning the set of channels, and a first interface configured to output the transmit sector sweep frames for transmission on the set of channels using different transmit beamforming sectors.

Certain aspects of the present disclosure provide an apparatus for wireless communications. The apparatus generally includes a first interface configured to obtain a plurality of transmit sector sweep frames on a set of channels, each of the transmit sector sweep frames comprising a preamble portion obtained on the set of channels, and a wideband training field obtained on a bandwidth spanning the set of channels, a processing system configured to select a transmit beamforming sector that was used to transmit one of the wideband training fields, based on received signal quality of the one of the training fields, and to generate a feedback frame indicating the transmit beamforming sector, and a second interface configured to output the feedback frame for transmission.

Certain aspects of the present disclosure provide a method for wireless communication. The method generally includes generating a plurality of transmit sector sweep frames for transmission on a set of channels, each of the transmit sector sweep frames comprising a preamble portion to be output for transmission on the set of channels, and a wideband training field to be output for transmission on a bandwidth spanning the set of channels, and outputting the transmit sector sweep frames for transmission on the set of channels using different transmit beamforming sectors.

Certain aspects of the present disclosure provide a method for wireless communication. The method generally includes obtaining a plurality of transmit sector sweep frames on a set of channels, each of the transmit sector sweep frames comprising a preamble portion obtained on the set of channels and a wideband training field obtained on a bandwidth spanning the set of channels, selecting a transmit beamforming sector that was used to transmit one of the wideband training fields, based on received signal quality of the one of the training fields, generating a feedback frame indicating the transmit beamforming sector, and outputting the feedback frame for transmission.

Certain aspects of the present disclosure provide an apparatus for wireless communications. The apparatus generally includes means for generating a plurality of transmit sector sweep frames for transmission on a set of channels, each of the transmit sector sweep frames comprising a preamble portion to be output for transmission on the set of channels and a wideband training field to be output for transmission on a bandwidth spanning the set of channels, and means for outputting the transmit sector sweep frames for transmission on the set of channels using different transmit beamforming sectors.

Certain aspects of the present disclosure provide an apparatus for wireless communications. The apparatus generally includes means for obtaining a plurality of transmit sector sweep frames on a set of channels, each of the transmit sector sweep frames comprising a preamble portion obtained on the set of channels and a wideband training field obtained on a bandwidth spanning the set of channels, means for selecting a transmit beamforming sector that was used to transmit one of the wideband training fields, based on received signal quality of the one of the training fields, means for generating a feedback frame indicating the transmit beamforming sector, and means for outputting the feedback frame for transmission.

Certain aspects of the present disclosure provide a computer-readable medium having instructions stored thereon for generating a plurality of transmit sector sweep frames for transmission on a set of channels, each of the transmit sector sweep frames comprising a preamble portion to be output for transmission on the set of channels and a wideband training field to be output for transmission on a bandwidth spanning the set of channels, and outputting the transmit sector sweep frames for transmission on the set of channels using different transmit beamforming sectors.

Certain aspects of the present disclosure provide a computer-readable medium having instructions stored thereon for obtaining a plurality of transmit sector sweep frames on a set of channels, each of the transmit sector sweep frames comprising a preamble portion obtained on the set of channels and a wideband training field obtained on a bandwidth spanning the set of channels, selecting a transmit beamforming sector that was used to transmit one of the wideband training fields, based on received signal quality of the one of the training fields, generating a feedback frame indicating the transmit beamforming sector, and outputting the feedback frame for transmission.

Certain aspects of the present disclosure provide a wireless node. The wireless node generally includes at least one antenna, a processing system configured to generate a plurality of transmit sector sweep frames for transmission on a set of channels, each of the transmit sector sweep frames comprising a preamble portion to be output for transmission on the set of channels and a wideband training field to be output for transmission on a bandwidth spanning the set of channels, and a first interface configured to output, via the at least one antenna, the transmit sector sweep frames for transmission on the set of channels using different transmit beamforming sectors.

Certain aspects of the present disclosure provide a wireless node. The wireless node generally includes at least one antenna, a first interface configured to obtain, via the at least one antenna, a plurality of transmit sector sweep frames on a set of channels, each of the transmit sector sweep frames comprising a preamble portion obtained on the set of channels and a wideband training field obtained on a bandwidth spanning the set of channels, a processing system configured to select a transmit beamforming sector that was used to transmit one of the wideband training fields, based on received signal quality of the one of the training fields, and to generate a feedback frame indicating the transmit beamforming sector, and a second interface configured to output the feedback frame for transmission via the at least one antenna.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates an example wireless communications network, in accordance with certain aspects of the present disclosure.

FIG. 2 is a block diagram of an example access point (AP) and STAs, in accordance with certain aspects of the present disclosure.

FIG. 3 is a block diagram of an example wireless device, in accordance with certain aspects of the present disclosure.

FIG. 4 is an example call flow illustrating a beam training phase, in accordance with certain aspects of the present disclosure.

FIG. 5 illustrates an example dual polarized patch element, in accordance with certain aspects of the present disclosure.

FIG. 6 is a diagram illustrating signal propagation in an implementation of phased-array antennas, in accordance with certain aspects of the present disclosure.

FIG. 7 is a timing diagram illustrating interframe space between beamforming (BF) frames, in accordance with certain aspects of the present disclosure.

FIG. 8 is a flow diagram of example operation for wireless communication by an initiator device, in accordance with certain aspects of the present disclosure.

FIG. 8A illustrates example means capable of performing the operations shown in FIG. 8.

FIG. 9 is a flow diagram of example operation for wireless communication by a responder device, in accordance with certain aspects of the present disclosure.

FIG. 9A illustrates example means capable of performing the operations shown in FIG. 9.

FIGS. 10A and 10B illustrate example transmit sector sweep frames for transmission using bonded channels, in accordance with certain aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects of the present disclosure generally relate to performing beamforming training for channel bonding. Certain aspects of the present disclosure provide transmit sector sweeps transmitted one a set of channels, and including a wideband training field transmitted on a bandwidth spanning the set of channels.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple stations. A TDMA system may allow multiple stations to share the same frequency channel by dividing the transmission signal into different time slots, each time slot being assigned to different stations. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA” such as an “AP STA” acting as an AP or a “non-AP STA”) or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the AT may be a wireless node. Such wireless node may provide, for example, connectivity for or to a network (e.g., a wide area network such as the Internet or a cellular network) via a wired or wireless communication link.

### An Example Wireless Communication System

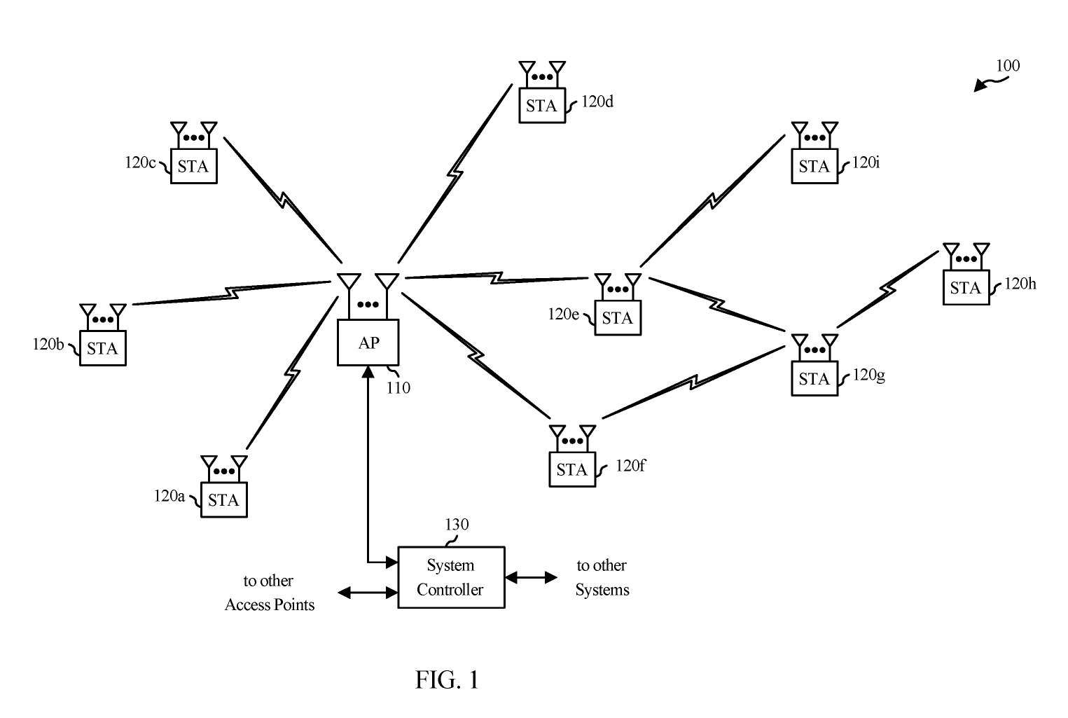

FIG. 1 illustrates a system 100 in which aspects of the disclosure may be performed. For example, an access point 120 may perform beamforming training to improve signal quality during communication with a station (STA) 120. The beamforming training may be performed using a MIMO transmission scheme.

The system 100 may be, for example, a multiple-access multiple-input multiple-output (MIMO) system 100 with access points and stations. For simplicity, only one access point 110 is shown in FIG. 1. An access point is generally a fixed station that communicates with the stations and may also be referred to as a base station or some other terminology. A STA may be fixed or mobile and may also be referred to as a mobile station, a wireless device, or some other terminology. Access point 110 may communicate with one or more STAs 120 at any given moment on the downlink and uplink. The downlink (i.e., forward link) is the communication link from the access point to the STAs, and the uplink (i.e., reverse link) is the communication link from the STAs to the access point. A STA may also communicate peer-to-peer with another STA.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe STAs 120 capable of communicating via Spatial Division Multiple Access (SDMA), for certain aspects, the STAs 120 may also include some STA that do not support SDMA. Thus, for such aspects, an AP 110 may be configured to communicate with both SDMA and non-SDMA STAs. This approach may conveniently allow older versions of STAs (“legacy” stations) to remain deployed in an enterprise, extending their useful lifetime, while allowing newer SDMA STAs to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected STAs 120 collectively represents the multiple-output for downlink transmissions and the multiple-input for uplink transmissions. For pure SDMA, it is desired to have Nₐₚ≥K≥1 if the data symbol streams for the K STAs are not multiplexed in code, frequency or time by some means. K may be greater than Nₐₚ if the data symbol streams can be multiplexed using TDMA technique, different code channels with CDMA, disjoint sets of subbands with OFDM, and so on. Each selected STA transmits user-specific data to and/or receives user-specific data from the access point. In general, each selected STA may be equipped with one or multiple antennas (i.e., Nᵤₜ≥1). The K selected STAs can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each STA may be equipped with a single antenna (e.g., in order to keep costs down) or multiple antennas (e.g., where the additional cost can be supported). The system 100 may also be a TDMA system if the STAs 120 share the same frequency channel by dividing transmission/reception into different time slots, each time slot being assigned to different STA 120.

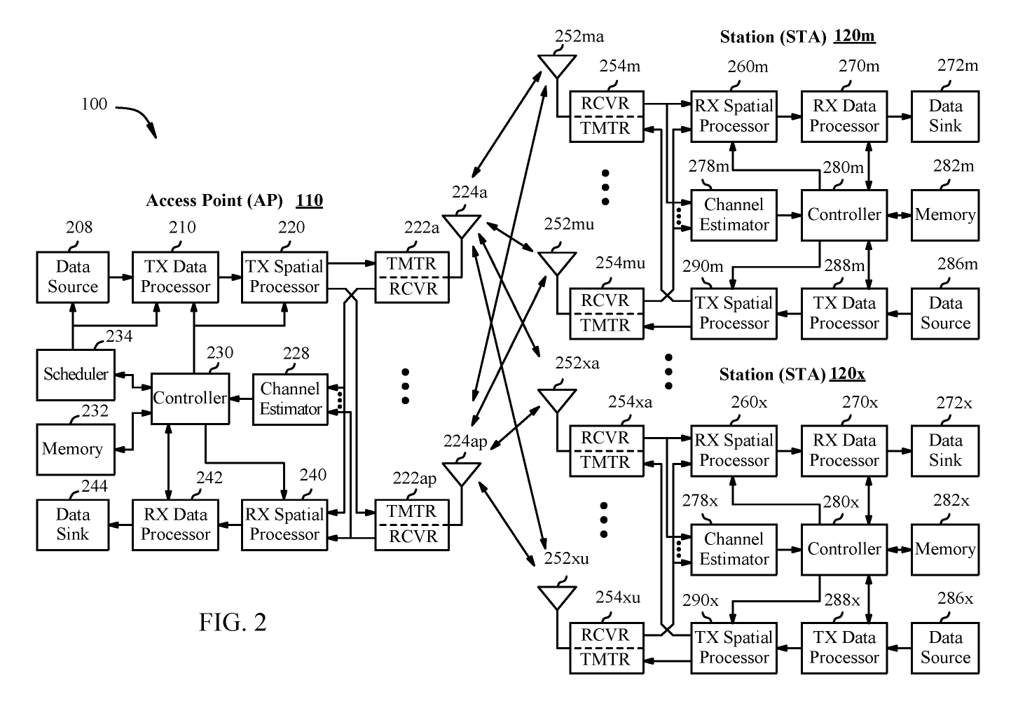

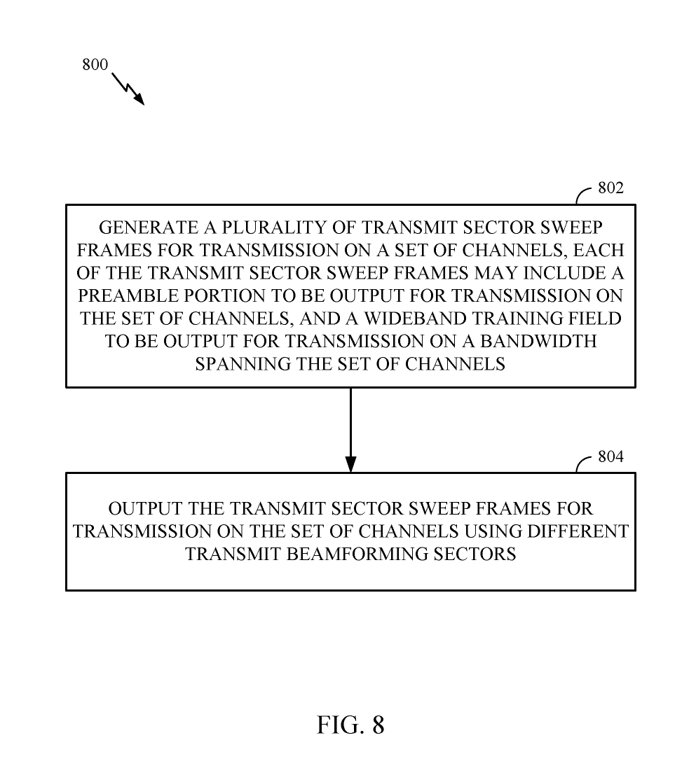

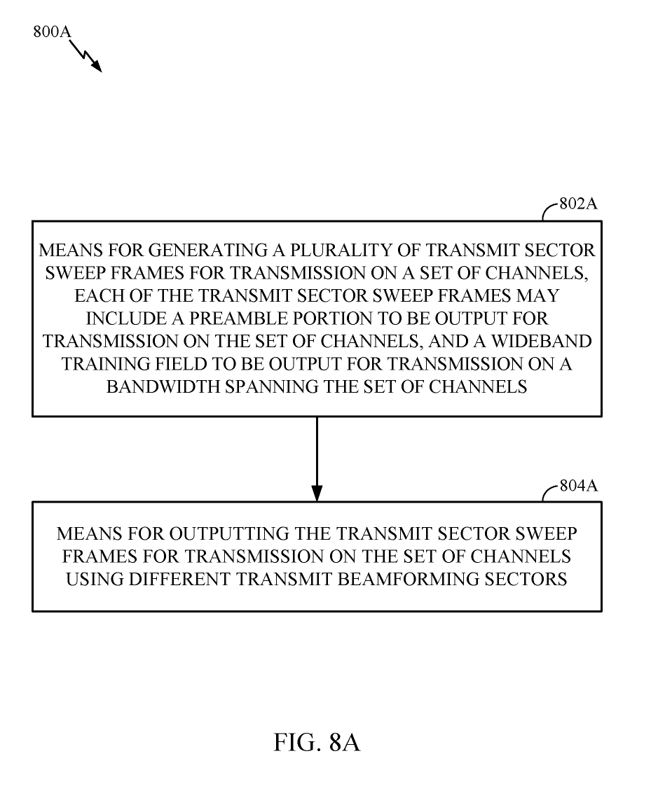

FIG. 2 illustrates example components of the AP 110 and UT 120 illustrated in FIG. 1, which may be used to implement aspects of the present disclosure. One or more components of the AP 110 and UT 120 may be used to practice aspects of the present disclosure. For example, antenna 224, Tx/Rx 222, processors 210, 220, 240, 242, and/or controller 230 or antenna 252, Tx/Rx 254, processors 260, 270, 288, and 290, and/or controller 280 may be used to perform the operations described herein and illustrated with reference to FIGS. 8 and 8A.

FIG. 2 illustrates a block diagram of access point 110 two STAs 120m and 120x in a MIMO system 100. The access point 110 is equipped with Nₜ antennas 224a through 224ap. STA 120m is equipped with N_{ut,m} antennas 252ma through 252mu, and STA 120x is equipped with N_{ut,x} antennas 252xa through 252xu. The access point 110 is a transmitting entity for the downlink and a receiving entity for the uplink. Each STA 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ STA are selected for simultaneous transmission on the uplink, N_{dn} STAs are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and STA.

On the uplink, at each STA 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the STA based on the coding and modulation schemes associated with the rate selected for the STA and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ STAs may be scheduled for simultaneous transmission on the uplink. Each of these STAs performs spatial processing on its data symbol stream and transmits its set of transmit symbol streams on the uplink to the access point.

At access point 110, Nₐₚ antennas 224a through 224ap receive the uplink signals from all Nᵤₚ STAs transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective STA. An RX data processor 242 processes (e.g., demodulates, deinterleaves, and decodes) each recovered uplink data symbol stream in accordance with the rate used for that stream to obtain decoded data. The decoded data for each STA may be provided to a data sink 244 for storage and/or a controller 230 for further processing. The controller 230 may be coupled with a memory 232.

On the downlink, at access point 110, a TX data processor 210 receives traffic data from a data source 208 for N_{dn} STAs scheduled for downlink transmission, control data from a controller 230, and possibly other data from a scheduler 234. The various types of data may be sent on different transport channels. TX data processor 210 processes (e.g., encodes, interleaves, and modulates) the traffic data for each STA based on the rate selected for that STA. TX data processor 210 provides N_{dn} downlink data symbol streams for the N_{dn} STAs. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the STAs. The decoded data for each STA may be provided to a data sink 272 for storage and/or a controller 280 for further processing.

At each STA 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the STA. The receiver spatial processing is performed in accordance with the CCMI, MMSE or some other technique. An RX data processor 270 processes (e.g., demodulates, deinterleaves and decodes) the recovered downlink data symbol stream to obtain decoded data for the STA.

At each STA 120, a channel estimator 278 estimates the downlink channel response and provides downlink channel estimates, which may include channel gain estimates, signal-to-noise ratio (SNR) estimates, noise variance and so on. Similarly, at access point 110, a channel estimator 228 estimates the uplink channel response and provides uplink channel estimates. Controller 280 for each STA typically derives the spatial filter matrix for the STA based on the downlink channel response matrix H_{dn,m} for that STA. Controller 230 derives the spatial filter matrix for the access point based on the effective uplink channel response matrix H_{up,eff}. Controller 280 for each STA may send feedback information (e.g., the downlink and/or uplink eigenvectors, eigenvalues, SNR estimates, and so on) to the access point. Controllers 230 and 280 also control the operation of various processing units at access point 110 and STA 120, respectively.

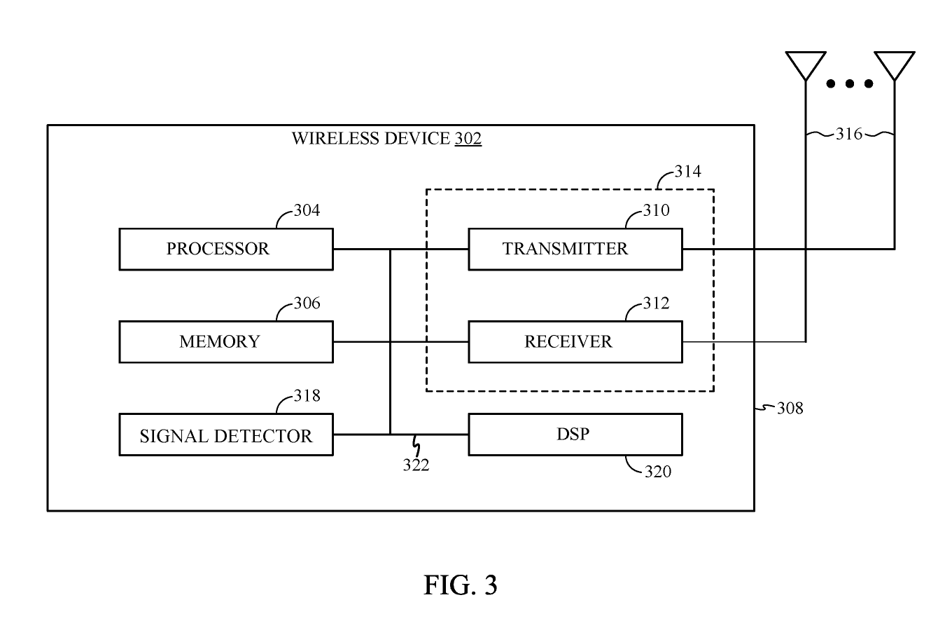

FIG. 3 illustrates various components that may be utilized in a wireless device 302 that may be employed within the MIMO system 100. The wireless device 302 is an example of a device that may be configured to implement the various methods described herein. For example, the wireless device may implement operations 800 and FIG. 8, respectively. The wireless device 302 may be an access point 110 or a STA 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote node. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Example Beamforming Training

Beamforming (BF) generally refers to a process used to control the directionality of transmission and reception of radio signals. BF may be used to determine relative rotation of devices (e.g., APs and/or non-AP STAs) based on training signals. In some cases, the training signals may be transmitted as part of a beamforming (BF) training process according to, for example, the IEEE 802.11ad standard. Knowing the relative rotation may allow each device to optimize antenna settings for transmit and reception.

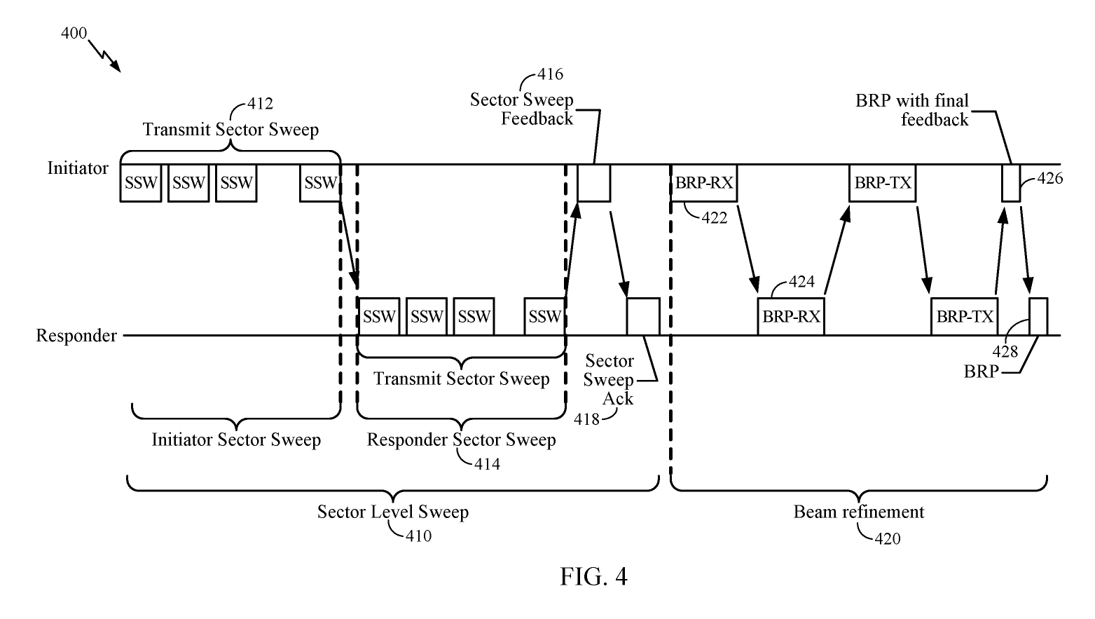

An example BF training process is illustrated in FIG. 4. The BF process is typically employed by a pair of millimeter-wave stations, e.g., a receiver and transmitter. Each pairing of the stations achieves the necessary link budget for subsequent communication among those network devices. As such, BF training typically involves a bidirectional sequence of BF training frame transmissions that uses sector sweep and provides the necessary signals to allow each station to determine appropriate antenna system settings for both transmission and reception. After the successful completion of BF training, a (e.g., millimeter-wave) communication link may be established.

The beamforming process can help address one of the problems for communication at the millimeter-wave spectrum, which is its high path loss. As such, a large number of antennas are place at each transceiver to exploit the beamforming gain for extending communication range. That is, the same signal is sent from each antenna in an array, but at slightly different times.

As shown in the example BF training process 400 illustrated in FIG. 4, the BF process may include a sector level sweep (SLS) phase 410 and a subsequent beam refinement stage 420. In the SLS phase, one of the STAs acts as an initiator by conducting an initiator sector sweep 412, which is followed by a transmit sector sweep 414 by the responding station (where the responding station conducts a responder sector sweep). A sector generally refers to either a transmit antenna pattern or a receive antenna pattern corresponding to a particular sector ID. As mentioned above, a station may have a transceiver that includes one or more active antennas in an antenna array (e.g., a phased antenna array).

The SLS phase 410 typically concludes after an initiating station receives sector sweep feedback 416 and sends a sector acknowledgement (ACK) 418, thereby establishing BF. Each transceiver of the initiator station and of the responding station is configured for conducting a receiver sector sweep (RXSS) reception of sector sweep (SSW) frames via different sectors, in which a sweep is performed between consecutive receptions and a transmission of multiple sector sweeps (SSW) (TXSS) or directional Multi-gigabit (DMG) beacon frames via different sectors, in which a sweep is performed between consecutive transmissions.

During the subsequent beam refinement phase 420, each station can sweep a sequence of transmissions (422 and 424), separated by a short beamforming interframe space (SBIFS) interval, in which the antenna configuration at the transmitter or receiver can be changed between transmissions, culminating in the exchange of final BRP feedback 426 and 428. In this manner, beam refinement is a process where a station can improve its antenna configuration (or antenna weight vector) both for transmission and reception. That is, each antenna includes an antenna weight vector (AWV), which further includes a vector of weights describing the excitation (amplitude and phase) for each element of an antenna array.

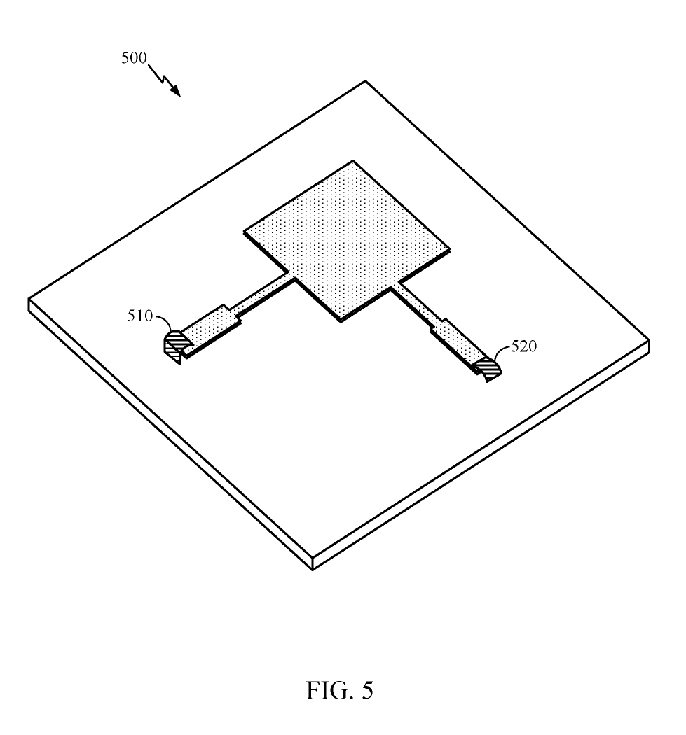

FIG. 5 illustrates an example dual polarized patch element 500 which may be employed, in accordance with certain aspects of the present disclosure. As shown in FIG. 5, a single element of an antenna array may contain multiple polarized antennas. Multiple elements may be combined together to form an antenna array. The polarized antennas may be radially spaced. For example, as shown in FIG. 5, two polarized antennas may be arranged perpendicularly, corresponding to a horizontally polarized antenna 510 and a vertically polarized antenna 520. Alternatively, any number of polarized antennas may be used. Alternatively or in addition, one or both antennas of an element may also be circularly polarized.

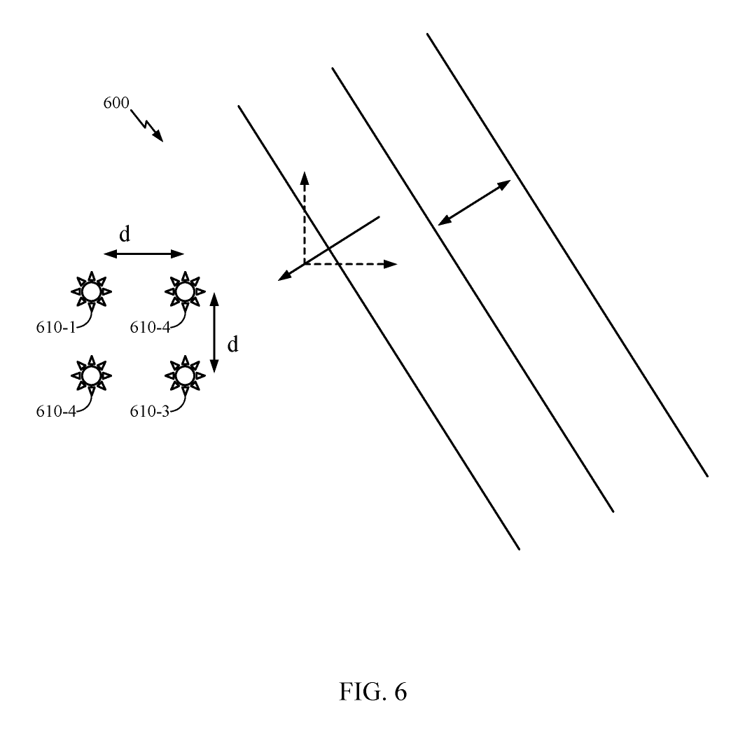

FIG. 6 is a diagram illustrating signal propagation 600 in an implementation of phased-array antennas. Phased array antennas use identical elements 610-1 through 610-4 (hereinafter referred to individually as an element 610 or collectively as elements 610). The direction in which the signal is propagated yields approximately identical gain for each element 610, while the phases of the elements 610 are different. Signals received by the elements are combined into a coherent beam with the correct gain in the desired direction. An additional consideration of the antenna design is the expected direction of the electrical field. In case the transmitter and/or receiver are rotated with respect to each other, the electrical field is also rotated in addition to the change in direction. This requires that a phased array be able to handle rotation of the electrical field by using antennas or antenna feeds that match a certain polarity and capable of adapting to other polarity or combined polarity in the event of polarity changes.

Information about signal polarity can be used to determine aspects of the transmitter of the signals. The power of a signal may be measured by different antennas that are polarized in different directions. The antennas may be arranged such that the antennas are polarized in orthogonal directions. For example, a first antenna may be arranged perpendicular to a second antenna where the first antenna represents a horizontal axis and the second antenna represents a vertical axis such that the first antenna is horizontally polarized and the second vertically polarized. Additional antennas may also be included, spaced at various angles in relation to each other. Once the receiver determines the polarity of the transmission the receiver may optimize performance by using the reception by matching the antenna to the received signal.

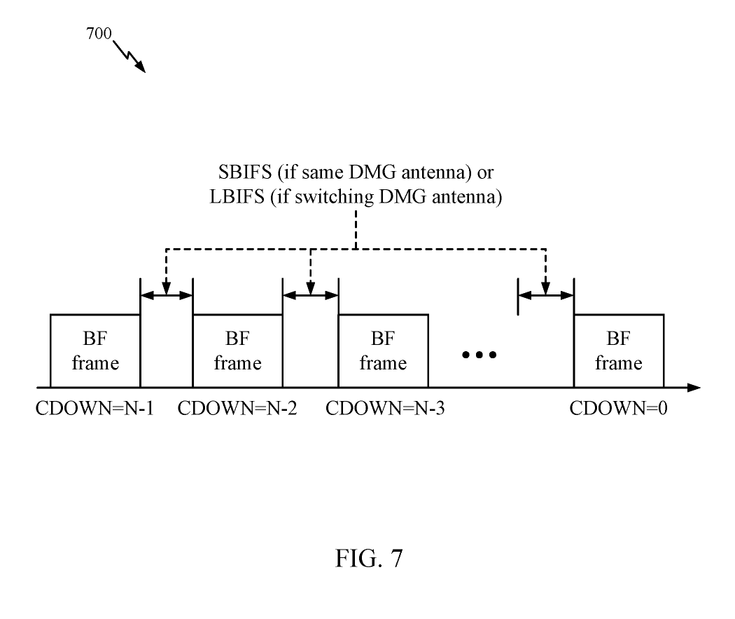

FIG. 7 is timing diagram 700 illustrating example interframe spacing between frames transmitted during BF. As illustrates, the interframe space between the BF frames may change in different scenarios. For example, a long beamforming interframe space (LBIFS) may be used if a transmitter has to change antennas (e.g., directional multi-gigabit (DMG) antennas), and a short beamforming interframe space (SBIFS) may be used otherwise.

### Example Wideband Sector Sweep Using Wideband Training (TRN) Field

New developing IEEE standards are increasing the physical layer (PHY) throughput for 60 GHz communication by using techniques such as MIMO, channel bonding and/or channel aggregation. Channel bonding generally refers to combining multiple channels within a given frequency band to increase throughput between two or more wireless nodes. Due to the high frequency of 60 GHz communication, high gain phased array antennas may be used to achieve reasonable ranges. Beamforming training is used to obtain beam direction for communication between wireless nodes. Beamforming training is a protocol that starts with transmit sector sweep frame transmissions as described above. The sector sweep protocol works by transmitting low rate control mode PHY sector sweep frames, which allow for communication at low SNRs and in different directions. However, when channel bonding is being used, the antenna sector selected using the sector sweep protocol may not be the best sector for the bonded channel. Certain aspects of the present disclosure provide techniques for performing wideband sector sweep for channel bonding.

As presented above, transmit sector sweep frames are transmitted in control mode PHY. In certain aspects, a duplicated control mode may be used in which the same packet is transmitted over multiple bonded channels. Certain aspects of the present disclosure provide for communication of sector sweep frames with wideband TRN sequences in order to obtain an estimate of the quality of a wideband channel. In certain aspects, the wideband TRN sequences are based on complementary Golay sequences and enable a wideband channel estimate that will enable estimating which channel has the highest quality.

FIG. 8 is a flow diagram of example operations 800 for wireless communications, in accordance with certain aspects of the present disclosure. The operations 800 may be performed by an apparatus (e.g., an initiator device), for example, by an access point (AP) or station (STA) (e.g., such as AP 110 or STA 120).

The operations 800 begin, at 802, by generating a plurality of transmit sector sweep frames for transmission on a set of channels. In certain aspects, each of the transmit sector sweep frames may include a preamble portion to be output for transmission on the set of channels, and a wideband training (TRN) field to be output for transmission on a bandwidth spanning the set of channels. The operations 800 continue, at block 804, by outputting the transmit sector sweep frames for transmission on the set of channels using different transmit beamforming sectors. In certain aspects, the operations 800 may also include obtaining an indication of one of the transmit beamforming sectors, and using the indicated transmit beamforming sector for communication with the wireless node.

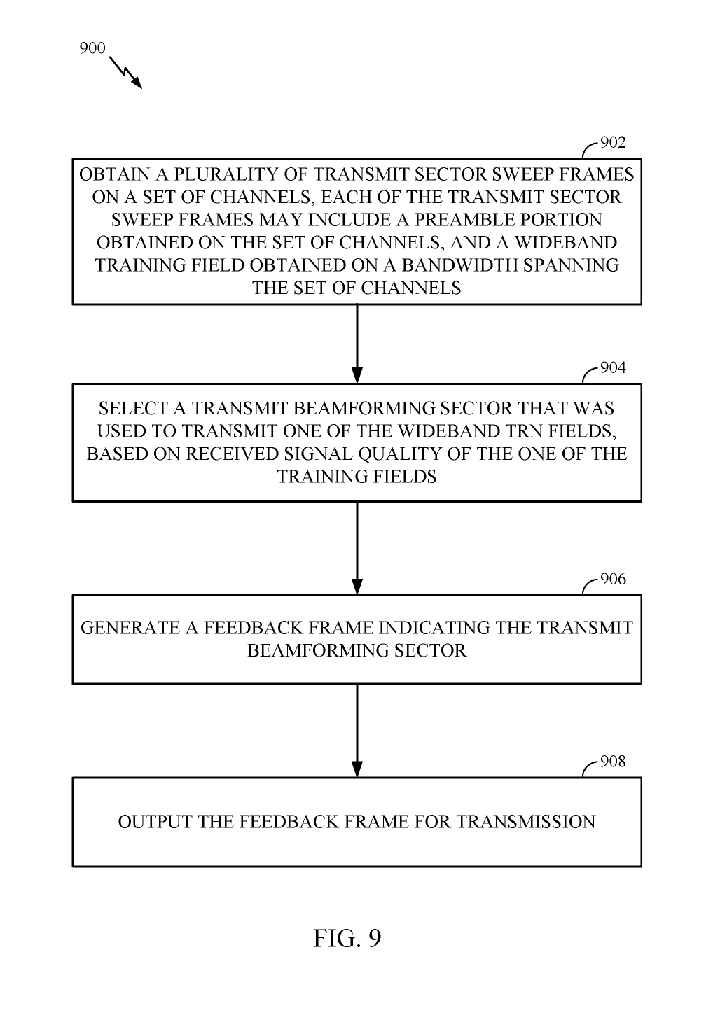

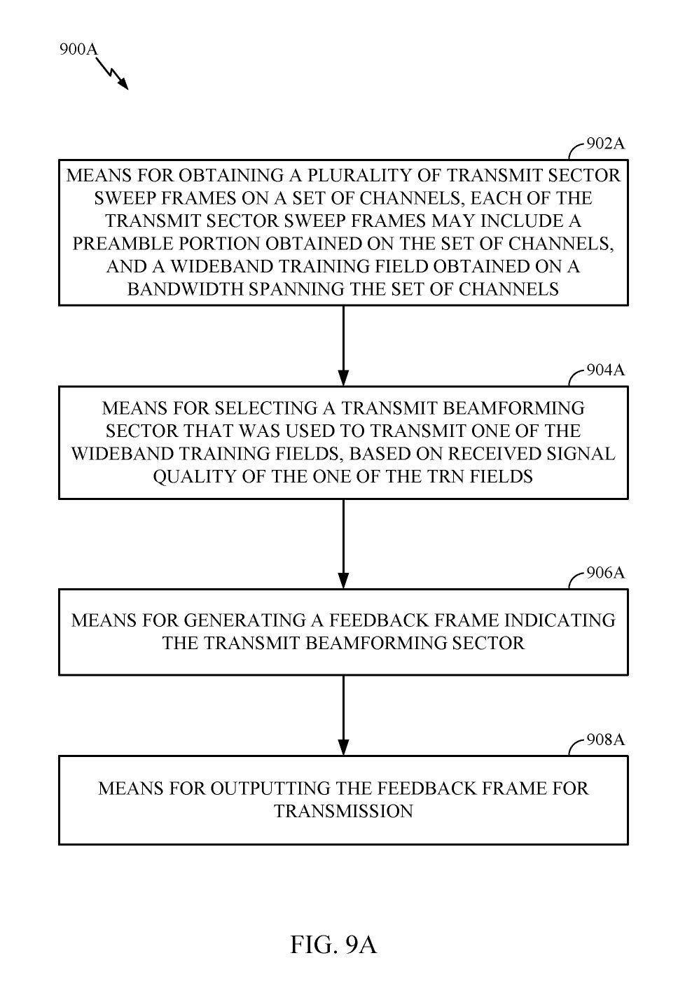

FIG. 9 is a flow diagram of example operations 900 for wireless communications, in accordance with certain aspects of the present disclosure. The operations 900 may be performed by an apparatus (e.g., a responder device), for example, by an access point (AP) or station (STA) (e.g., such as AP 110 or STA 120).

The operations 900 begin, at 902, obtaining a plurality of transmit sector sweep frames on a set of channels. In certain aspects, each of the transmit sector sweep frames may include a preamble portion obtained on the set of channels, and a wideband TRN field obtained on a bandwidth spanning the set of channels. In certain aspects, the operations 900 also include, at block 904, selecting a transmit beamforming sector that was used to transmit one of the wideband TRN fields, based on received signal quality of the one of the TRN fields, and, at block 906, generating a feedback frame indicating the transmit beamforming sector. At block 908, the feedback frame may be output for transmission.

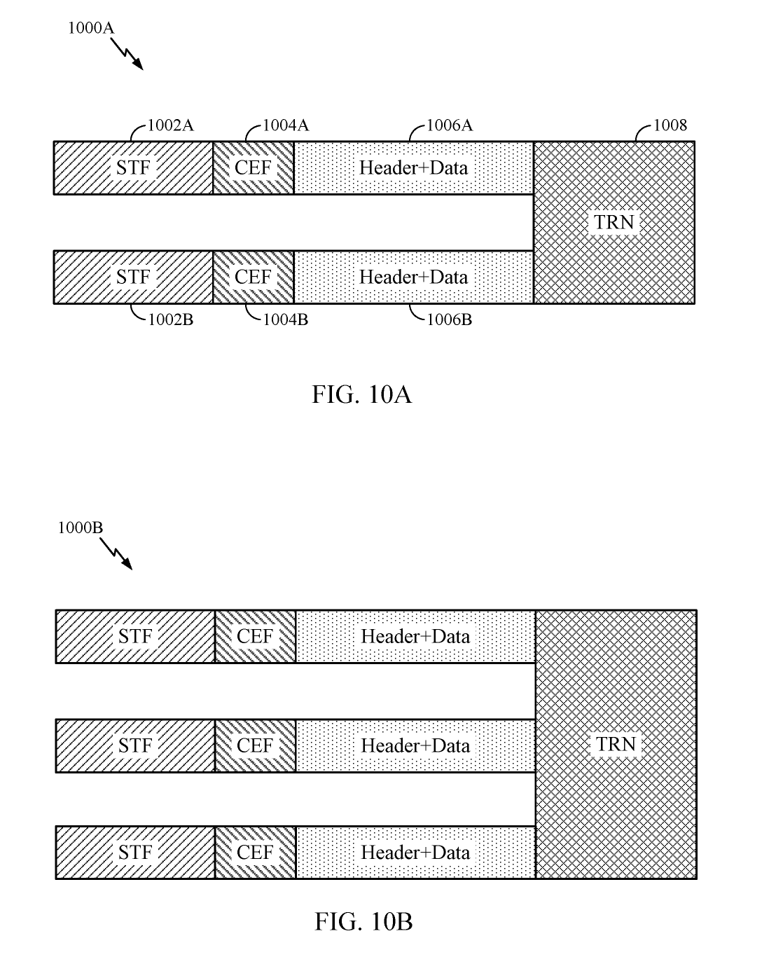

In some cases, the set of channels may include a first channel and a second channel, wherein the preamble portion is repeated in each of the first channel and the second channel (e.g., using channel bonding). In some cases, the first channel and the second channel may be adjacent channels. In certain aspects, the preamble portion may include an indication of a presence of the wideband TRN field. For example, the preamble portion may include an enhanced directional multi-gig (EDMG) header field comprising the indication of the presence of the wideband TRN field. For example, the EDMG header field may be an EDMG header-A field. The operations 900 and 800 are explained in more detail with respect to FIGS. 10A and 10B.

FIGS. 10A and 10B illustrate example transmit sector sweep frames 1000A and 1000B for transmission using bonded channels, in accordance with certain aspects of the present disclosure. As illustrated in FIG. 10A, each of the transmit sector sweep frames may include a preamble portion which may include a short training field (STF) 1002A and 1002B and a channel estimation field (CEF) 1004A and 1004B. The STF 1002A and/or 1002B may be used to perform timing estimation and the CEF 1004A and/or 1004B may be used to performed channel estimation. The STFs and CEFs may be compliant with IEEE 802.11ad standard. In certain aspects, each of the transmit sector sweep frames 1000 may include a header and data field 1006A and 1006B. The header field may be an EDMG control PHY header and may include an indication of the bandwidth of the transmit sector sweep frames 1000. In certain aspects, at least one the STF 1002B, the CEF 1004B, or the header and data field 1006B may be a duplicate of the STF 1002A, the CEF 1004A, or the header and data field 1006A, respectively.

In certain aspects, the header field may indicate the presence of a wideband TRN field 1008. In certain aspects, each of the transmit sector sweep frames may include an EDMG header. In certain aspects, the EDMG header may be used to indicate the existence of the wideband TRN field 1008. In certain aspects, each of the transmit sector sweep frames 1000A and 1000B may also include a directional multi-gigabit (DMG) header field. While the example communication protocol of FIG. 10A uses two bonded channels to facilitate understanding, any number of bonded channels may be used. For example, the transmit sector sweep frames 1000B of FIG. 10B are transmitted using three bonded channels.

The initiator device may transmit sector sweep frames on a set of channels and in a set of directions (e.g., a set of sectors). At this time, a responder device may be listening with an omni antenna pattern. The responder device may select the sector corresponding to one of the sector sweep frames having the best quality. The selection of the sector may be based on the wideband TRN field of each of the sector sweep frames. Since the wideband TRN field is transmitted on a bandwidth spanning the set of channels, the selected sector may correspond to the best quality sector for communication using channel bonding of the set of channels.

In certain aspects, the responder device responds by sending a similar set of sector sweep frames including a wideband TRN fields when the initiator is listening with an omni antenna pattern. In each of the sector sweep frames the responder transmits, the responder may indicate which sector of the sector sweep frames transmitted by the initiator had the best quality as determined based on the wideband TRN fields. The initiator device then responds by transmitting a packet to the responder device indicating which sector of the sector sweep frames transmitted by the responder device had the best quality (e.g., as determined based on the wideband TRN fields of the sector sweep frames transmitted by the responder device). In some cases, an acknowledgement (ACK) frame may be transmitted by the responder device to close the set of transmission, sent using the best responder sector.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame, a device may have an interface to output a frame for transmission. For example, a processor may output a frame, via a bus interface, to an RF front end for transmission. Similarly, rather than actually receiving a frame, a device may have an interface to obtain a frame received from another device. For example, a processor may obtain (or receive) a frame, via a bus interface, from an RF front end for transmission.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 800 illustrated in FIG. 8 correspond to means 800A illustrated in FIG. 8A, respectively.

For example, means for receiving and means for obtaining may be a receiver (e.g., the receiver unit of transceiver 254) and/or an antenna(s) 252 of the STA 120 illustrated in FIG. 2 or the receiver (e.g., the receiver unit of transceiver 222) and/or antenna(s) 224 of access point 110 illustrated in FIG. 2. Means for transmitting and means for outputting may be a transmitter (e.g., the transmitter unit of transceiver 254) and/or an antenna(s) 252 of the STA 120 illustrated in FIG. 2 or the transmitter (e.g., the transmitter unit of transceiver 222) and/or antenna(s) 224 of access point 110 illustrated in FIG. 2.

Means for estimating, means for using, means for selecting, means for performing, means for generating, means for including, means for adjusting, means for determining, and means for providing may comprise a processing system, which may include one or more processors, such as the RX data processor 270, the TX data processor 288, and/or the controller 280 of the STA 120 illustrated in FIG. 2 or the TX data processor 210, RX data processor 242, and/or the controller 230 of the access point 110 illustrated in FIG. 2. Means for outputting may be a transmitter or may be a bus interface, for example, to output a frame from a processor to an RF front end for transmission.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a STA 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media. Thus, certain aspects may comprise a computer-readable medium having instructions stored (and/or encoded) thereon, the instructions being executable by one or more processors to perform the operations described herein.

Further, it should be appreciated that modules and/or other appropriate means for performing the methods and techniques described herein can be downloaded and/or otherwise obtained by a STA and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a STA and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communication, comprising:
a processing system configured to generate a plurality of transmit sector sweep frames for transmission on a set of channels, each of the transmit sector sweep frames comprising:
a preamble portion to be output for transmission on the set of channels; and
a wideband training field to be output for transmission on a bandwidth spanning
the set of channels; and
a first interface configured to output the transmit sector sweep frames for transmission on the set of channels using different transmit beamforming sectors.

2. The apparatus of claim 1, wherein the set of channels comprise a first channel and a second channel, wherein the preamble portion is repeated in each of the first channel and the second channel.

3. The apparatus of claim 2, wherein the transmit sector sweep frames are output for transmission on the first channel and the second channel using channel bonding.

4. The apparatus of claim 2, wherein the first channel and the second channel are adjacent channels.

5. The apparatus of claim 1, wherein the preamble portion comprises an indication of a presence of the wideband training field.

6. The apparatus of claim 5, wherein the preamble portion comprises an enhanced directional multi-gigabit (EDMG) header field comprising the indication of the presence of the wideband training field.

7. The apparatus of claim 1, wherein the preamble portion further comprises a short training field (STF) and a channel estimation field (CEF).

8. The apparatus of claim 7, wherein the STF and the CEF are compatible with the IEEE 802.11 ad standard.

9. The apparatus of claim 1, wherein the preamble portion comprises directional multi-gigabit (DMG) header and an EDMG header and data field.

10. The apparatus of claim 1, wherein:
the first interface is configured to output the transmit sector sweep frames for transmission to a wireless node;
the apparatus further comprises a second interface configured to obtain, from the wireless node, an indication of one of the transmit beamforming sectors; and
the apparatus is configured to use the indicated transmit beamforming sector for communication with the wireless node.

11-56. (canceled)

57. A wireless node, comprising:
at least one antenna;
a processing system configured to generate a plurality of transmit sector sweep frames for transmission on a set of channels, each of the transmit sector sweep frames comprising:
a preamble portion to be output for transmission on the set of channels; and
a wideband training field to be output for transmission on a bandwidth spanning
the set of channels; and
a first interface configured to output, via the at least one antenna, the transmit sector sweep frames for transmission on the set of channels using different transmit beamforming sectors.

58-59. (canceled)

60. A method for wireless communication, comprising:
generating a plurality of transmit sector sweep frames for transmission on a set of channels, each of the transmit sector sweep frames comprising:
a preamble portion to be output for transmission on the set of channels; and
a wideband training field to be output for transmission on a bandwidth spanning
the set of channels; and
outputting the transmit sector sweep frames for transmission on the set of channels using different transmit beamforming sectors.

61. The method of claim 60, wherein the set of channels comprise a first channel and a second channel, wherein the preamble portion is repeated in each of the first channel and the second channel.

62. The method of claim 61, wherein the transmit sector sweep frames are output for transmission on the first channel and the second channel using channel bonding.

63. The method of claim 61, wherein the first channel and the second channel are adjacent channels.

64. The method of claim 60, wherein the preamble portion comprises an indication of a presence of the wideband training field.

65. The method of claim 64, wherein the preamble portion comprises an enhanced directional multi-gigabit (EDMG) header field comprising the indication of the presence of the wideband training field.

66. The method of claim 60, wherein the preamble portion further comprises a short training field (STF) and a channel estimation field (CEF).

67. The method of claim 60, wherein the preamble portion comprises directional multi-gigabit (DMG) header and an EDMG header and data field.

68. The method of claim 60, wherein:
the transmit sector sweep frames is output for transmission to a wireless node; and the method further comprises:
obtaining, from the wireless node, an indication of one of the transmit beamforming sectors; and
using the indicated transmit beamforming sector for communication with the wireless node.
